(19) United States
(12) Patent Application Publication
(10) Pub. No.: US 2022/0143797 A1
(43) Pub. Date: May 12, 2022

(54) DRIVING TOOL

(71) Applicant: KOKI HOLDINGS CO., LTD., Tokyo (JP)

(72) Inventor: Yoshinori ISHIZAWA, Ibaraki (JP)

(21) Appl. No.: 17/434,319

(22) PCT Filed: Jan. 31, 2020
(86) PCT No.: PCT/JP2020/003667

§ 371 Date: Aug. 26, 2021

(30) Foreign Application Priority Data
Mar. 1, 2019 (JP) 2019-037232

(51) Int. Cl. B25C 1/04

(52) U.S. Cl. CPC B25C 1/04

(57) ABSTRACT

Provided a driving tool capable of reducing power supplied to an actuator. It includes: an accumulator 21 accommodating a gas; a pressure chamber to which the gas is supplied from the accumulator 21; a striking part operating by pressure in the pressure chamber; a trigger valve 45 having an initial state of shutting off the accumulator 21 and the pressure chamber, and an operating state of connecting the accumulator 21 and the pressure chamber; a mode switching mechanism having a connection mode of transmitting to the trigger valve 45 an operating force applied to the operating member, and a shut-off mode of preventing the operating force applied to the operating member being transmitted to the trigger valve 45; a valve 75 having, when the mode switching mechanism is in the shut-off mode, a supply state of supplying a gas in the accumulator 21 to the trigger valve 45 to make the trigger valve 45 an operating state, and a discharge state of discharging the gas supplied to the trigger valve 45 to make the trigger valve 45 an initial state; and a solenoid 76 switching the supply state and the discharge state of the valve 75.

### TECHNICAL FIELD

The present invention relates to a driving tool including a striking part and a driving part for operating the striking part.

### BACKGROUND ART

Patent Document 1 discloses an example of a driving tool including a striking part and a driving part for operating the striking part. The driving tool disclosed in Patent Document 1 has a motor, a magazine, a flywheel, a rotating shaft, the striking part, a coil spring, a clutch mechanism, a solenoid as an actuator, a trigger, and a push lever. Fasteners accommodated in the magazine are sent to a hitting position. Rotational energy of the motor is stored in the flywheel.

When an operating force to the trigger is released or applied or when the push lever is separated from a workpiece, a supply of power to the solenoid is stopped. When the supply of power to the solenoid is stopped, the clutch mechanism shuts off the flywheel and the rotating shaft.

When the operating force is applied to the trigger and the push lever is pressed against the workpiece, power is supplied to the solenoid. When the power is supplied to the solenoid, the clutch mechanism connects the flywheel to the rotating shaft. When the flywheel and the rotating shaft are connected, the striking part operates and the striking part hits the fastener at the hitting position.

### RELATED ART DOCUMENTS

### Patent Documents

Patent Document 1: Japanese Patent Application Laid-open No. 2007-118134

### SUMMARY OF THE INVENTION

### Problems to be Solved by the Invention

The inventor of the present application has recognized a problem in which the power supplied to the actuator increases since the clutch mechanism is operated by supplying the power to the actuator.

An object of the present invention is to provide a driving tool capable of reducing the power supplied to the actuator.

### Means for Solving the Problems

A driving tool of one embodiment includes: a gas accommodating chamber accommodating a gas; a pressure chamber to which the gas is supplied from the gas accommodating chamber; a striking part operating in a direction of hitting a fastener by pressure in the gas supplied to the gas accumulating chamber; an operating member to and from which an operating force of a user is applied and released; a switching mechanism having a first state of shutting off the gas accommodating chamber and the pressure chamber when an operating force to the operating member is released, and a second state of connecting the gas accommodating chamber and the pressure chamber when the operating force to the operating member is applied; a mode switching mechanism having a connection mode of transmitting to the switching mechanism the operating force applied to the operating member, and a shut-off mode of preventing the operating force applied to the operating member being transmitted to the switching mechanism; a valve having, when the mode switching mechanism is in the shut-off mode, a supply state of supplying the gas in the gas accommodating chamber to make the switching mechanism to the switching mechanism the second state, and a discharge state of discharging the gas supplied to the switching mechanism to make the switching mechanism the first state; and an actuator operating by a supply of power and switching the supply state and the discharge state of the valve.

### EFFECTS OF THE INVENTION

The driving tool of one embodiment can reduce the power supplied to the actuator.

### BRIEF DESCRIPTION OF THE DRAWINGS

FIG. 1 is an overall cross-sectional view showing a first embodiment of a driving tool included in the present invention;

FIG. 2 is a cross-sectional view of the driving tool of FIG. 1 in which an operating force is applied to a trigger in a first mode and a striking part is located at a bottom dead center in a state where a push lever contacts with a workpiece;

FIG. 3 is a cross-sectional view of the driving tool of FIG. 1 in which an operating force is applied to the trigger in the first mode and the striking part is located at atop dead center in a state where the push lever contacts with the workpiece;

FIG. 4 is a cross-sectional view showing initial states of a trigger valve and a valve when a third mode is selected by the driving tool of FIG. 1;

FIG. 5 is a cross-sectional view showing operating states of the trigger valve and the valve when the third mode is selected by the driving tool of FIG. 1;

FIGS. 6(A) and (B) are cross-sectional views each showing a state of the trigger valve in a state where the first mode is selected;

FIG. 7 is a block diagram showing a control system of the driving tool;

FIG. 8 is a flowchart of a control example in the third mode;

FIG. 9 is an overall cross-sectional view showing a second embodiment of the driving tool;

FIG. 10 is a cross-sectional view of the driving tool of FIG. 9 in which a third mode is selected to apply an operating force to a trigger and a striking part is located at a bottom dead center in a state where a push lever contacts with a workpiece;

FIG. 11 is a cross-sectional view of the driving tool of FIG. 9 in which the third mode is selected to apply the operating force to the trigger and the striking part located at a top dead center in the state where the push lever contacts with the workpiece;

FIG. 12 is a cross-sectional view of the driving tool of FIG. 9 in which the third mode is selected to apply the operating force to the trigger and a valve is in a discharge state in the state where the push lever contacts with the workpiece;

FIG. 13 is a cross-sectional view of the driving tool of FIG. 9 in which the third mode is selected to apply the operating force to the trigger and the valve is in a supply state in the state where the push lever contacts with the workpiece;

FIG. 14 is a cross-sectional view of the driving tool of FIG. 9 in which the third mode is selected and the trigger valve and the push lever valve are in initial states; and

FIG. 15 is a cross-sectional view of the driving tool of FIG. 9 in which the third mode is selected and the trigger valve and the push lever valve are in operating states.

### DETAILED DESCRIPTION OF PREFERRED EMBODIMENTS

Next, a typical one among some embodiments included in a driving tool of the present invention will be described with reference to the drawings.

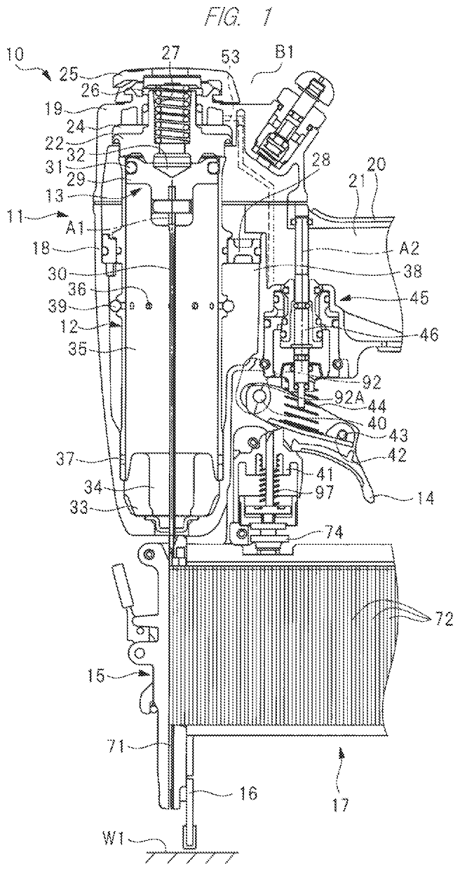

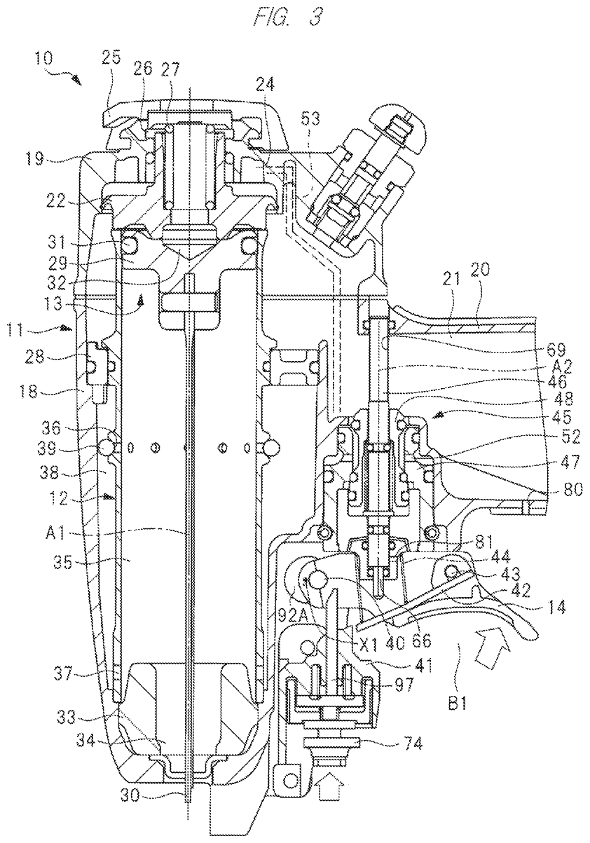

(First Embodiment) A first embodiment of a driving tool will be described with reference to the drawings. A driving tool 10 shown in FIGS. 1, 2, and 3 has a housing 11, a cylinder 12, a striking part 13, a trigger 14, an ejection part 15, and a push lever 16. Further, a magazine 17 attached to the driving tool 10 is provided. The housing 11 has a cylindrical body part 18, a head cover 19 fixed to the body part 18, and a handle 20 connected to the body part 18. An accumulator 21 is formed over an inside of the handle 20, an inside of the body part 18, and an inside of the head cover 19. An air hose is connected to the handle 20. Compressed air as a gas is supplied to the accumulator 21 via the air hose. A cylinder 12 is provided in the body part 18.

A head valve 22 is provided in the head cover 19. The head valve 22 is movable in a direction along a center line A1 of the cylinder 12. The head valve 22 is made of synthetic rubber as an example. The head valve 22 is energized in a direction away from the cylinder 12 by air pressure in the accumulator 21. A gas chamber 24 is formed between the head valve 22 and the head cover 19. A stopper 25 is attached to the head cover 19. An exhaust passage 26 is formed between the head cover 19 and the stopper 25. The exhaust passage 26 is connected to an exterior B1 of the housing 11.

An energizing member 27 is provided between the head valve 22 and the stopper 25. The energizing member 27 is, as an example, a metal spring. The energizing member 27 energizes the head valve 22 in a direction along the center line A1 so as to approach the cylinder 12. The cylinder 12 is positioned and fixed with respect to the body part 18 in the direction along the center line A1. A holder 28 is provided in the body part 18. The holder 28 positions the cylinder 12 with respect to the body part 18 in a direction intersecting with the center line A1.

The striking part 13 has a piston 29 and a driver blade 30. The piston 29 is arranged in the cylinder 12, and the striking part 13 is operable in the direction along the center line A1. A sealing member 31 is attached to the piston 29. A piston upper chamber 32 is formed between the head valve 22 and the piston 29.

The ejection part 15 is fixed to the body part 18 at an end portion opposite to a portion where the head cover 19 is provided in the direction along the center line A1. A bumper 33 is provided in the body part 18. The bumper 33 is arranged in the body part 18 at a position closest to the ejection part 15. The bumper 33 is made of synthetic rubber or silicon rubber. The bumper 33 has a shaft hole 34, and the driver blade 30 is movable in the shaft hole 34 in the direction along the center line A1.

A piston lower chamber 35 is formed between the piston 29 and the bumper 33 in the cylinder 12. The sealing member 31 airtightly shuts off the piston lower chamber 35 and the piston upper chamber 32. The cylinder 12 has passages 36 and 37. The passage 37 is arranged between the passage 36 and the ejection part 15 in the direction along the center line A1. A return air chamber 38 is formed between the cylinder 12 and the body part 18. The holder 28 airtightly separates the return air chamber 38 and the accumulator 21. A check valve 39 is attached to an outer peripheral surface of the cylinder 12. The check valve 39 opens and closes the passage 36. The passage 37 always connects the piston lower chamber 35 and the return air chamber 38. Air is present in the piston lower chamber 35 and the return air chamber 38.

The trigger 14 is attached to the housing 11. The trigger 14 is rotatable about a support shaft 40 with respect to the housing 11 within a predetermined angle range. The housing 11 has a stopper 41, and the stopper 41 prevents an operating range of the trigger 14. An arm 42 is attached to the trigger 14. The arm 42 is operable with respect to the trigger 14 about the support shaft 43. An energizing member 44 is provided between the arm 42 and the housing 11. The energizing member 44 energizes the trigger 14 and the arm 42 in a direction away from the handle 20. The energizing member 44 is, as an example, a metal spring. The trigger 14 and the arm 42, which are energized by a force of the energizing member 44, contact with the stopper 41 and respectively stop as shown in FIG. 1.

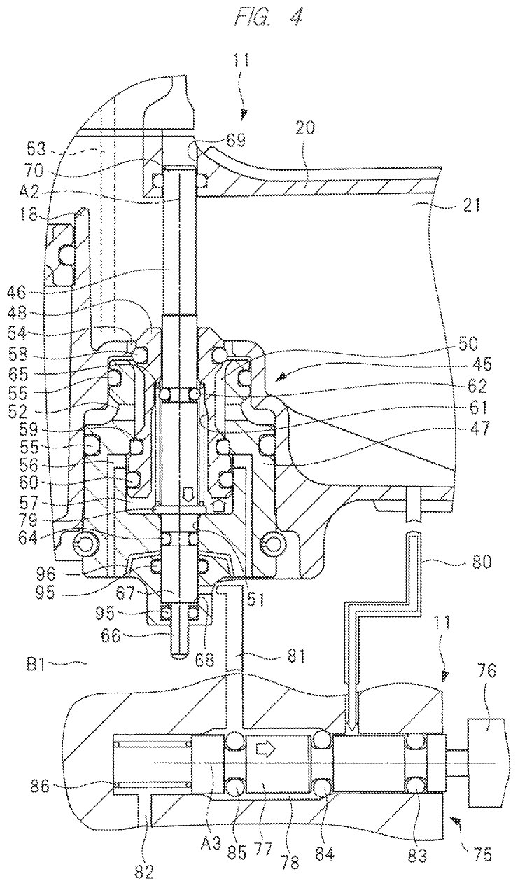

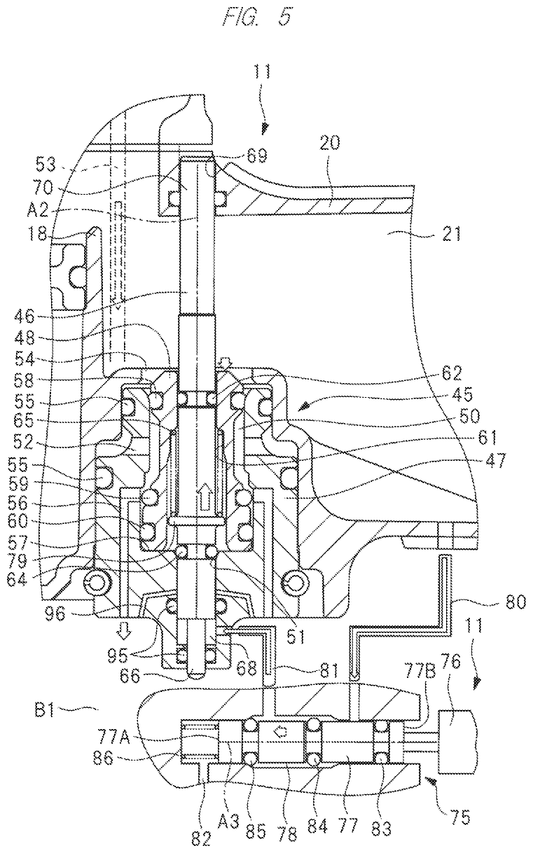

As shown in FIGS. 4 and 5, a trigger valve 45 is provided at a connection portion between the body part 18 and the handle 20. The trigger valve 45 includes a plunger 46, a body 47, a valve element 48, and an energizing member 65. The body 47 has an accommodation recess portion 50 and a shaft hole 51. The shaft hole 51 and the accommodation recess portion 50 connect to each other. An opening of the accommodation recess portion 50 is connected to the accumulator 21. The valve element 48 has a cylindrical shape, and the valve element 48 is arranged in the accommodation recess portion 50. The valve element 48 is operable in the direction along the center line A2 with respect to the body 47. The center line A2 is each center of the valve element 48 and the plunger 46. The plunger 46 is arranged over the accommodation recess portion 50, the shaft hole 51, and the exterior B1 of the housing 11. The plunger 46 is operable in the direction along the center line A2 with respect to the body 47 and the valve element 48.

A passage 52 is provided in the body 47, and the passage 52 is connected to the gas chamber 24 via the passage 53. Further, the housing 11 has a passage 54, and the passage 54 connects the accumulator 21 and the accommodation recess portion 50. A sealing member 55 is provided to seal a portion between the body 47 and the housing 11. The body 47 has an exhaust passage 56, and the exhaust passage 56 connects to the exterior B1. The exhaust passage 56 connects to the accommodation recess portion 50. A space 57 is formed between the valve element 48 and the body 47. The space 57 connects to the shaft hole 51. The valve element 48 is energized by pressure in the space 57 in a direction of approaching the accumulator 21.

Sealing members 58, 59, 60 are attached to an outer peripheral surface of the valve element 48. The valve element 48 has a shaft hole 61. The sealing member 60 shuts off the space 57 and the exhaust passage 56. The plunger 46 is arranged over the shaft hole 51 and the shaft hole 61. Sealing members 62 and 64 are attached to an outer peripheral surface of the plunger 46. A flange 79 projecting from the outer peripheral surface of the plunger 46 is provided. The energizing member 65 is provided in the shaft hole 61. The energizing member 65 is, as an example, a metal compression spring, and the energizing member 65 energizes the plunger 46 in a direction along a center line A2 so as to approach the arm 42. Further, the energizing member 65 energizes the valve element 48 in a direction of approaching the accumulator 21.

In the plunger 46, a land portion 67 is provided between the flange 79 and a first end portion 66. The first end portion 66 is a position closest to the arm 42 in the direction along the center line A2 of the plunger 46. A gas chamber 68 is formed between an end surface of the land portion 67 and the body 47 in the shaft hole 51. Two sealing members 95 are attached to the body 47, and the two sealing members 95 airtightly seal the gas chamber 68. Further, the body 47 has an exhaust passage 96, and the exhaust passage 96 connects the shaft hole 51 and the exterior B1.

A shaft hole 69 is provided in the housing 11, and a second end portion 70 of the plunger 46 is arranged in the shaft hole 69. The second end portion 70 is located in the direction along the center line A2 and opposite the first end portion 66. The second end portion 70 is movable in the shaft hole 69 in the direction along the center line A2. The shaft hole 69 connects to the exterior B1 of the housing 11. The second end portion 70 is exposed to the exterior B1. The ejection part 15 is, as an example, made of metal or non-ferrous metal. The ejection part 15 has an ejection path 71. The center line A1 is located in the ejection path 71, and the driver blade 30 is movable in the direction along the center line A1 in the ejection path 71. The magazine 17 is fixed to the ejection part 15. The magazine 17 accommodates fasteners 72. The magazine 17 has a feeder, and the feeder sends the fasteners 72 in the magazine 17 to the ejection path 71.

A shaft member 74 connected to the push lever 16 is provided. The shaft member 74 is movable with respect to the stopper 41. The shaft member 74 is energized by the energizing member 97 in a direction away from the arm 42. The energizing member 97 is, as an example, a compression spring. Further, a valve 75 is provided in the housing 11. The valve 75 has a plunger 77 and a support hole 78. The support hole 78 is provided in the housing 11, and the plunger 77 is arranged in the support hole 78. The plunger 77 is made of metal, i.e., iron or an aluminum alloy as an example. The plunger 77 is operable in a direction along a center line A3.

Further, a solenoid 76 is provided as an actuator for operating the valve 75. The solenoid 76 forms a magnetic attraction force when a current flows. The solenoid 76 releases the magnetic attraction force when no current flows. The plunger 77 is connected to the solenoid 76 and is operable by the magnetic attraction force. The housing 11 has passages 80 and 81 and an exhaust passage 82, and the passage 80 connects to the accumulator 21 and is open to the support hole 78. The passage 81 connects to the gas chamber 68 and is open to the support hole 78. The exhaust passage 82 connects to the exterior B1 and is open to the support hole 78. Sealing members 83, 84, 85 are attached to the outer peripheral surface of the plunger 77. An emerging member 86 is provided in the support hole 78. The energizing member 86 energies the plunger 77 in the direction along the center line A3. The energizing member 86 is, as an example, a metal spring. The plunger 77 operates by the magnetic attraction force of the solenoid 76 and an energizing force of the energizing member 86.

The plunger 77 stops at an initial position when the sealing member 84 is pressed against an inner surface of the support hole 78 as shown in FIG. 4. In the valve 75, when the plunger 77 stops at the initial position, the sealing member 84 shuts off the passage 80 and the passage 81. Further, the valve 75 connects the passage 81 and the exhaust passage 82. When the solenoid 76 forms the magnetic attraction force, the plunger 77 operates against the energizing force of the energizing member 86. The plunger 77 stops at an operating position where the sealing member 84 is separated from the stopper as shown in FIG. 5. The plunger 77 stops at the operating position. When the plunger 77 stops at the operating position, the sealing member 85 shuts off the passage 81 and the exhaust passage 82. Further, the valve 75 connects the passage 80 and the passage 81.

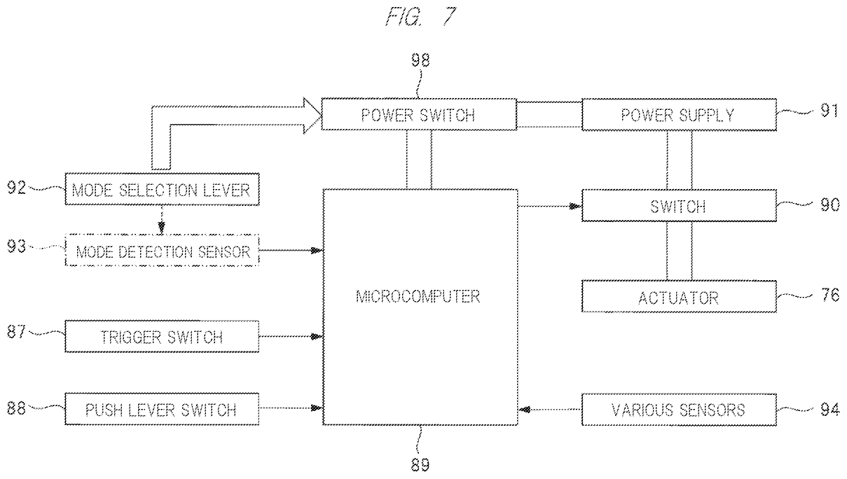

FIG. 7 is a block diagram showing a control system of the driving tool 10. A trigger switch 87 is provided in the housing 11, and the trigger switch 87 detects application and release of the operating force to and from the trigger 14, and outputs a signal.

The trigger switch 87 may be either a contact type sensor or a non-contact type sensor. A push lever switch 88 is provided in the housing 11, and the push lever switch 88 detects whether the push lever 16 is pressed against the workpiece W1 or the push lever 16 is separated from the workpiece W1, and outputs a signal. The push lever switch 88 may be either a contact type sensor or a non-contact type sensor.

A microcomputer 89 is provided in the housing 11 as an example. The microcomputer includes an arithmetic processing unit, a memory, and a timer. The microcomputer 89 processes the signal of the trigger switch 87 and the signal of the push lever switch 88. A power supply 91 connected to the valve 75 via a switch 90 is provided. As the power supply 91, at least one of a solar panel, a DC power supply, an AC power supply, a capacitor, and the like can be used. The solar panel is a panel for generating electricity with sunlight, and the solar panel can be provided on an outer surface of the housing 11. The DC power supply may be either a primary battery or a secondary battery, and the DC power supply is provided in the housing 11 or the magazine 17 as an example. The capacitor is a passive element that stores and releases electric charges. The capacitors can also be defined as capacitors. The capacitor can be provided in the housing 11 or the magazine 17 as an example. The AC power supply is connected to the housing 11 via a power cable. The power cable can also be attached to an air hose connected to the handle 20.

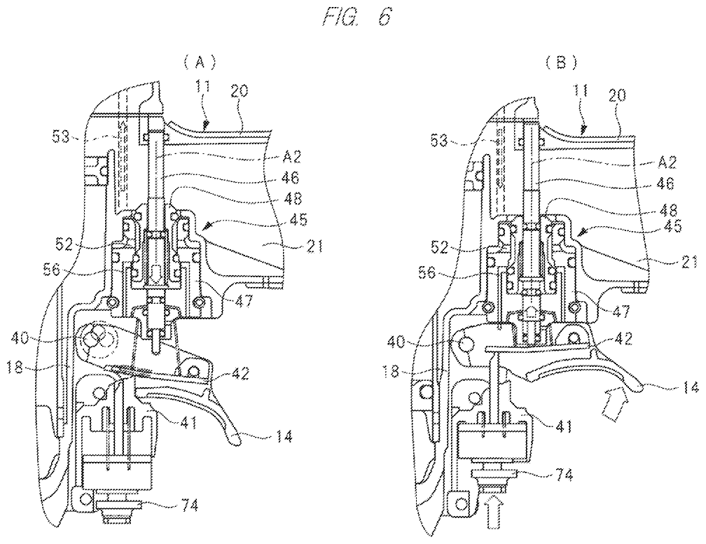

A mode selection lever 92 shown in FIG. 1 is attached to the housing 11. The mode selection lever 92 is provided so as to be operable to the housing 11 about an operating shaft 92A, that is, to be rotatable. A user can operate the mode selection lever 92 to mutually switch any one of a first mode, a second mode, and a third mode. The support shaft 40 is provided on the operating shaft 92A and is provided at a position eccentric from a rotation center X1 of the operating shaft 92A. When the mode selection lever 92 is operated, the support shaft 40 revolves as shown in FIG. 6(A).

A position of the support shaft 40 in the first mode is a position farthest from the plunger 46. A position of the support shaft 40 in the third mode is a position closest to the plunger 46. A position of the support shaft 40 in the second mode is between the position of the support shaft 40 in the first mode and the position of the support shaft 40 in the third mode. The position of the support shaft 40 is a position in a direction intersecting with the center line A2. Therefore, when the mode is switched, the arm 42 operates in the direction intersecting with the center line A2 regardless of whether an operating force is applied to the trigger 14.

The switch 90 forms part of an electrical circuit between the power supply 91 and the solenoid 76. The microcomputer 89 controls on and off of the switch 90. When the microcomputer 89 turns off the switch 90, no current is supplied from the power supply 91 to the solenoid 76. When the microcomputer 89 turns on the switch 90, a current is supplied from the power supply 91 to the solenoid 76. The user selects the first mode before pressing the push lever 16 against the workpiece W1 to use the driving tool 10 while applying the operating force to the trigger 14.

The user selects the second mode before applying an operating force to the trigger 14 to use the driving tool 10 while pressing the push lever 16 against the workpiece W1. When the microcomputer 89 detects the first mode or the second mode, the microcomputer 89 turns off the switch 90. The user can select the third mode before pressing the push lever 16 against the workpiece W1 to use the driving tool 10 while applying the operating force to the trigger 14. When the microcomputer 89 detects the third mode, the microcomputer 89 can turn on the switch 90.

Further, a power switch 98 for switching on and off when the mode selection lever 92 is operated is provided. The power switch 98 is turned off when the first mode or the second mode is selected, and is turned on when the third mode is selected. When the power switch 98 is turned off, no current is supplied from the power supply 91 to the microcomputer 89 and the microcomputer 89 is stopped. When the power switch 98 is turned on, a current is supplied from the power supply 91 to the microcomputer 89 and the microcomputer 89 is started. Incidentally, various sensors 94 may be provided in the housing 11. The various sensors 94 include at least one or more of a pressure sensor, a temperature sensor, a humidity sensor, and an acceleration sensor. If the housing 11 is provided with a display unit, the microcomputer 89 processes signals of various sensors 94 and can display or warn, on the display unit, an operating time from an operation of the user to an operation of the striking part 13, operating speed of the striking part 13, and inspection timing and repair timing of the bumper 33.

Next, an example in which the user uses the driving tool 10 will be described for each mode selected by the user.

(Example in which User selects Third Mode) When the user selects the third mode, the arm 42 separates from the plunger 46 even if the user applies the operating force to the trigger 14 and presses the push lever 16 against the workpiece W1. The arm 42 does not transmit the operating force of the trigger 14 and the operating force of the push lever 16 to the plunger 46. Therefore, the trigger valve 45 maintains an initial state. The microcomputer 89 switches a state of the trigger valve 45 by processing a signal of the trigger switch 87 and a signal of the push lever switch 88 to control supply and stop of the current to and from the solenoid 76.

When the microcomputer 89 detects that the operating force to the trigger 14 is released and the push lever 16 separates from the workpiece W1, the microcomputer 89 turns off the switch 90. Further, when the microcomputer 89 detects that the operating force is applied to the trigger 14 and the push lever 16 separates from the workpiece W1, the microcomputer 89 turns off the switch 90. When the microcomputer 89 turns off the switch 90, no current flows through the solenoid 76. Therefore, as shown in FIG. 4, the valve 75 is in a discharge state in which the gas chamber 68 and the exhaust passage 82 are connected and the accumulator 21 and the passage 81 are shut off. Further, the trigger valve 45 is in the initial state. As shown in FIG. 4, the flange 79 is pressed against the body 47 by the energizing member 65. The sealing member 64 shuts off the space 57 and the exhaust passage 96. The valve element 48 is energized in the direction away from the arm 42 by the energizing force of the energizing member 65, and the sealing member 59 is pressed against the body 47 to cause the valve element 48 to stop at the initial position.

The sealing member 59 shuts off the passage 52 and the exhaust passage 56. The sealing member 58 separates from the body 47, and the accumulator 21 is connected to the gas chamber 24 via the passage 52 and the passage 53. The sealing member 62 separates from the valve element 48, and the accumulator 21 connects to the space 57 via the shaft hole 61. The sealing member 64 shuts off the space 57 and the exterior B1.

When the trigger valve 45 is in the initial state, compressed air in the accumulator 21 is supplied to the gas chamber 24. Therefore, the head valve 22 is stopped in the initial state shown in FIG. 1. The head valve 22 stopped in the initial state shuts off the piston upper chamber 32 and the accumulator 21, and opens the exhaust passage 26. Therefore, the piston upper chamber 32 connects to the exterior B1. Further, when the head valve 22 is stopped in the initial state, the striking part 13 stops at a top dead center with the piston 29 contacting with the head valve 22.

Next, the microcomputer 89 starts the timer when the operating force is applied to the trigger 14. The microcomputer 89 turns on the switch 90 when it detects that the push lever 16 has been pressed against the workpiece W1 within a predetermined time from a time point when the operating force is applied to the trigger 14. By doing so, a current flows through the solenoid 76, and the valve 75 switches from a discharge state shown in FIG. 4 to a supply state shown in FIG. 5. The valve 75 in the supply state connects the passage 81 and the passage 80, and shuts off the passage 81 and the exhaust passage 82. Therefore, the compressed air in the accumulator 21 is supplied to the gas chamber 68 through the passages 80 and 81, and pressure in the gas chamber 68 rises.

Consequently, the plunger 46 of the trigger valve 45 operates against the energizing force of the energizing member 65, and the plunger 46 stops at the operating position. The sealing member 64 moves to the space 57, and the space 57 and the exterior B1 connect to each other via the shaft hole 51 and the exhaust passage 96. Further, the sealing member 62 is pressed against the valve element 48, and the sealing member 62 seals the shaft hole 61. Therefore, the valve element 48 operates against the force of the energizing member 65 by the pressure of the accumulator 21, and the sealing member 58 shuts off the accumulator 21 and the passage 52. In addition, the sealing member 59 separates from the body 47, and the passage 52 and the exhaust passage 56 connect to each other. Therefore, the compressed air in the gas chamber 24 is discharged to the exterior B1 through the passage 53, the passage 52, and the exhaust passage 56. In this way, a state in which the trigger valve 45 shuts off the accumulator 21 and the passage 52 and connects the passage 52 and the exhaust passage 56 is the operating state of the trigger valve 45.

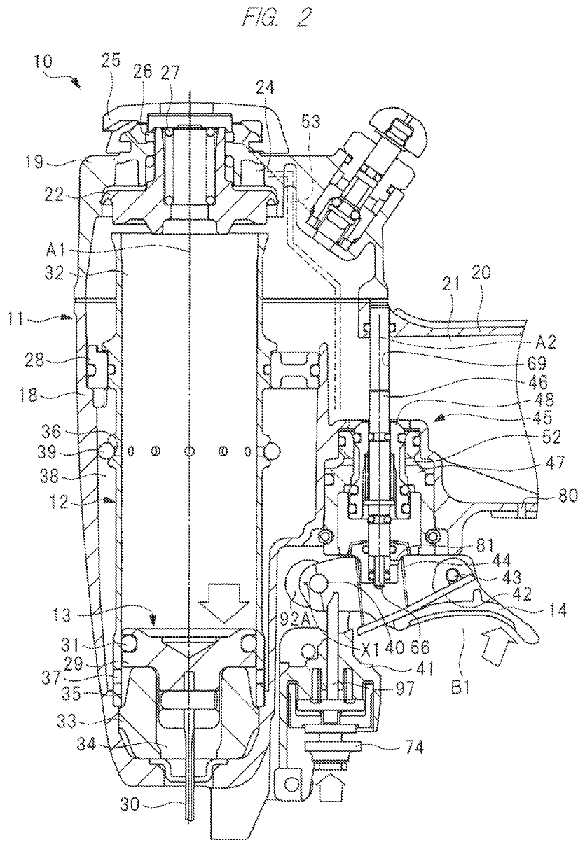

When air is discharged from the gas chamber 24, the head valve 22 operates by the pressure in the accumulator 21. As shown in FIG. 2, the head valve 22 is stopped in an operating state of separating from the cylinder 12. The stopped head valve 22 connects the accumulator 21 and a piston upper chamber 32, and shuts off the exhaust passage 26. The compressed air in the accumulator 21 is supplied to the piston upper chamber 32, and pressure in the piston upper chamber 32 rises. The striking part 13 descends from a top dead center toward a bottom dead center under the pressure in the piston upper chamber 32. The driver blade 30 hits the fastener 72 in the ejection path 71, and the fastener 72 is driven into the workpiece W1. Further, as shown in FIG. 2, the piston 29 collides with the bumper 33. A position of the striking part 13 at a time point when the piston 29 collides with the bumper 33 is the bottom dead center. In addition, while the striking part 13 is descending, pressure in the piston lower chamber 35 rises.

After the striking part 13 reaches the bottom dead center, the microcomputer 89 turns off the switch 90 when it detects that the push lever 16 has separated from the workpiece W1. Consequently, the solenoid 76 releases the magnetic attraction force, and the plunger 77 of the valve 75 stops at the initial position shown in FIG. 4 by the energizing member 86 and a pressing force due to a diameter difference between the sealing member 83 and the sealing member 85. Therefore, the air in the gas chamber 68 is discharged to the exterior B1. Consequently, the plunger 46 operates by the energizing force of the energizing member 65 and the pressing force due to the diameter difference between the sealing member 64 and the sealing member 62, and the plunger 46 stops at the initial position shown in FIG. 4. Further, the valve element 48 operates by the energizing force of the energizing member 65, connects the accumulator 21 and the passage 52, and shuts off the passage 52 and the exhaust passage 56. In this way, the trigger valve 45 switches from the operating state to the initial state.

When the trigger valve 45 switches from the operating state to the initial state, the head valve 22 operates to be pressed against the cylinder 12 and the head valve 22 shuts off the accumulator 21 and the piston upper chamber 32 and opens the exhaust passage 26. Consequently, the striking part 13 rises due to the pressure in the piston lower chamber 35, and the striking part 13 stops at the top dead center shown in FIG. 1. The user selects the third mode, and can drive the fastener 72 into the workpiece W1 by operating to press the push lever 16 against the workpiece W1 within a predetermined time from a time point when the operating force is applied to the trigger 14. Accordingly, when the predetermined time elapses with the operating force applied to the trigger 14, the fastener 72 cannot be driven even if the push lever 16 is pressed against the workpiece W1.

Meanwhile, the microcomputer 89 continues to turn off the switch 90 when the operating force is applied to the trigger 14 and a predetermined time elapses in a state where the push lever 16 separates from the workpiece W1. Therefore, when the push lever 16 is pressed against the workpiece W1 after the predetermined time has passed from the time point when the operating force is applied to the trigger 14, the trigger valve 45 maintains the initial state. That is, the striking part 13 stops at the top dead center. The microprocessor 89 resets the timer once the user releases the operating force to the trigger 14.

The microcomputer 89 switches the valve 75 between the discharge state shown in FIG. 4 and the supply state shown in FIG. 5. Switching between the initial state and the operating state of the trigger valve 45 is performed according to the pressure in the gas chamber 68. That is, the solenoid 76 only controls the operation of the plunger 77 of the valve 75. In other words, the magnetic attraction force of the solenoid 76 required to operate the plunger 77 is lower than an operating force required to operate the valve element 48 of the trigger valve 45 against air pressure in the accumulator 21. This makes it possible to prevent the solenoid 76 becoming large. Further, the magnetic attraction force of the solenoid 76 changes according to the current supplied from the power supply 91. Therefore, this makes it possible to suppress an increase in a voltage applied to the solenoid 76 and reduce an output of the power supply 91. If the power supply 91 is a DC power supply that can be attached to and detached to and from the housing 11 or the magazine 17, it can be a small-capacity DC power supply.

Further, the second end portion 70 of the plunger 46 is arranged at a position where it receives atmospheric pressure. The second end portion 70 is exposed to the exterior B1. Therefore, when the plunger 46 is operated from the initial position to the operating position, an area where the plunger 46 receives the pressure in the accumulator 21 can be narrowed. Accordingly, a force required to operate the plunger 46 from the initial position to the operating position can be reduced. Further, an end portion 77A of the plunger 77, which is close to the energizing member 86, is arranged at a position of receiving the atmospheric pressure of the exterior B1 as shown in FIG. 5. Therefore, the force required to operate the plunger 77 can be reduced. Further, an end portion 77B of the plunger 77, which is close to the solenoid 76, is arranged at a position of receiving the atmospheric pressure of the exterior B1. Therefore, the force required to operate the plunger 77 can be reduced.

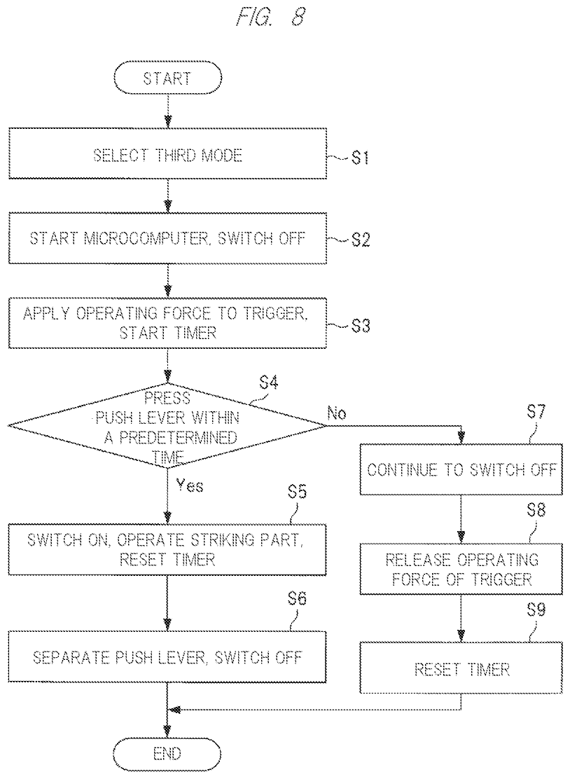

FIG. 8 is a flowchart showing a usage example of the driving tool 10. When the user selects the third mode in step S1, the power switch 98 is turned on in step S2 to start the microcomputer 89. Further, the switch 90 is off at a time point when the microcomputer 89 is started. When the microprocessor 89 detects that the operating force is applied to the trigger 14 in step S3, the microprocessor 89 starts the timer.

The microcomputer 89 determines in step S4 whether the push lever 16 is pressed against the workpiece W1 within a predetermined time. When the microcomputer 89 determines Yes in step S4, the microcomputer 89 turns on the switch 90. Therefore, the striking part 13 operates from the top dead center toward the bottom dead center. When the microcomputer 89 detects that the push lever 16 has been separated from the workpiece W1 in step S6, it turns off the switch 90 and ends a routine of FIG. 8.

When the microcomputer 89 determines No in step S4, it continues to turn off the switch 90 in step S7. Even if the push lever 16 is pressed against the workpiece W1 in a state of step S7, the switch 90 maintains off. When the microprocessor 89 detects that the operating force of the trigger 14 is released in step S8, it resets the timer in step S9 and ends the routine of FIG. 8. When the user selects the first mode or the second mode in step S1, the routine of FIG. 8 is not performed and the microcomputer 89 is stopped.

(Example in which User selects First Mode) When the user selects the first mode, the microcomputer 89 is stopped and the switch 90 is off. When the user selects the first mode and the operating force to the trigger 14 is released to separate the push lever 16 from the workpiece W1, the arm 42 separates from the plunger 46 as shown in FIG. 6(A). That is, the trigger valve 45 is maintained in the initial state. Further, when the user selects the first mode and the operating force is applied to the trigger 14 to separate the push lever 16 from the workpiece W1, the trigger valve 45 is maintained in the initial state.

The user selects the first mode and the push lever 16 is pressed against the workpiece W1 in a state of applying the operating force to the trigger 14. Consequently, the operating forces of the trigger 14 and the push lever 16 are transmitted to the plunger 46 via the arm 42 as shown in FIG. 6B. The plunger 46 operates against the energizing force of the energizing member 65, and the trigger valve 45 switches from the initial state to the operating state. The striking part 13 operates from the top dead center toward the bottom dead center.

When the push lever 16 is separated from the workpiece W1 in a state where the user applies the operating force to the trigger 14 after the striking part 13 reaches the bottom dead center, the plunger 46 is operated by the energizing force of the energizing member 65 and stops at the initial position. The trigger valve 45 switches from the operating state to the initial state. The striking part 13 operates from the bottom dead center toward the top dead center, and the striking part 13 stops at the top dead center.

While the user selects the first mode to maintain the state of applying the operating force to the trigger 14, the user can repeat more than once an operation of pressing the push lever 16 against the workpiece W1 and an operation of separating the push lever 16 from the workpiece W1.

(Example in which User selects Second Mode) When the user selects the second mode, the microcomputer 89 is stopped. When the user selects the second mode and the push lever 16 is separated from the workpiece W1 to release the operating force to the trigger 14, the trigger valve 45 maintains the initial state. Further, even when the user selects the second mode and the push lever 16 is pressed against the workpiece W1 to release the operating force to the trigger 14, the trigger valve 45 maintains the initial state.

When the user selects the second mode and the operating force is applied to the trigger 14 in the state of pressing the push lever 16 against the workpiece W1, the operating force of the push lever 16 and the operating force of the trigger 14 are transmitted to the plunger 46 via the arm 42, as shown in FIG. 6(B). The trigger valve 45 switches from the initial state to the operating state, and the striking part 13 operates from the top dead center toward the bottom dead center.

When the user releases the operating force to the trigger 14 to separate the push lever 16 from the workpiece W1 after the striking part 13 reaches the bottom dead center, the plunger 46 operates by the energizing force of the energizing member 65 and the trigger valve 45 switches from the operating state to the initial state. The striking part 13 operates from the bottom dead center toward the top dead center and the striking part 13 stops at the top dead center.

When the user selects the second mode, the user can repeat more than once an operation of applying the operating force to the trigger 14 with the push lever 16 pressed against the workpiece W1 and an operation of separating the push lever 16 from the workpiece W1 to release the operating force to the trigger 14.

Incidentally, when the second mode is selected and when the push lever 16 is pressed against the workpiece W1 in the state of applying the operating force to the trigger 14, the shaft member 74 does not contact with the arm 42. Therefore, the trigger valve 45 is maintained in the initial state shown in FIG. 4.

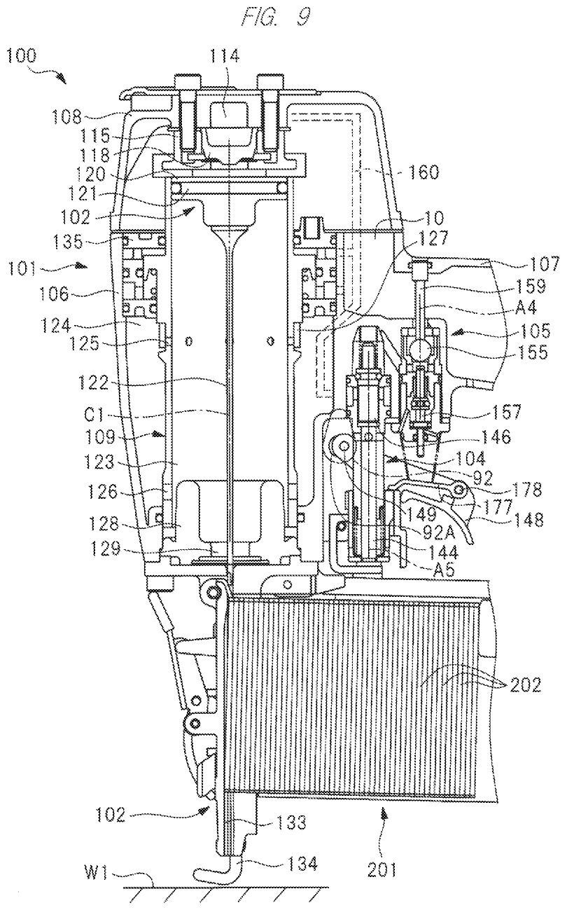

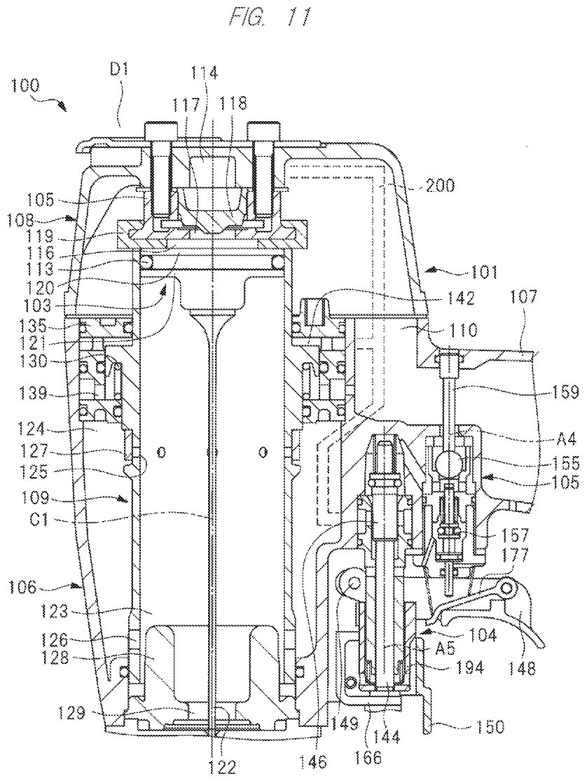

(Second Embodiment) A second embodiment of a driving tool is shown in FIGS. 9, 10, and 11. A driving tool 100 includes a housing 101, an ejection part 102, a striking part 103, a push lever valve 104, and a trigger valve 105. The housing 101 has a body part 106, a handle 107, and a head cover 108. The body part 106 has a cylindrical shape, and the handle 107 is connected to the body part 106. The head cover 108 is fixed to a first end portion of the body part in a longitudinal direction of the body part 106. The ejection part 102 is fixed to a second end portion of the body part in the longitudinal direction of the body part 106. An air hose is connected to the handle 107. The striking part 103 is provided in the body part 106. The striking part 103 is operable in a direction of a center line C1.

A cylinder 109 is provided in the body part 106. The center line C1 is a center line of the cylinder 109. The cylinder 109 is movable along the center line C1. The holder 135 is provided in the body part 106. The holder 135 has an annular shape, and the holder 135 positions the cylinder 109 with respect to the body part 106 in a direction intersecting with the center line C1. An accumulator 110 is provided in the handle 107, the body part 106, and the head cover 108. Compressed air supplied from the air hose is accumulated in the accumulator 110. The holder 135 forms a first gas chamber 139 and a second gas chamber 142. The first gas chamber 139 is always connected to the accumulator 110.

A mount part 115 is fixed to an inner surface of the head cover 108. An exhaust valve chamber 114 is formed between the head cover 108 and the mount part 115. The mount part 115 has an exhaust passage 117. The exhaust passage 117 connects to an exterior D1 of the housing 101. The mount part 115 supports the exhaust valve 118. The exhaust valve 118 is movable in the direction of the center line C1 with respect to the mount part 115. The exhaust valve 118 opens and closes the exhaust passage 117.

A valve seat 119 is attached to the mount part 115. The valve seat 119 is made of synthetic rubber, and the valve seat 119 has a passage 116. The passage 116 connects to the exhaust passage 117.

The striking part 103 has a piston 121 and a driver blade 122. The piston 121 is provided in the cylinder 109, and the piston 121 is operable in the cylinder 109 in the direction of the center line C1. A piston upper chamber 120 is formed between the piston 121 and the valve seat 119. The piston upper chamber 120 connects to the passage 116. The piston 121 receives pressure in the piston upper chamber 120, and is energized in a direction away from the valve seat 119 and in a direction along the center line C1. A sealing member 113 is attached to an outer peripheral surface of the piston 121. The sealing member 113 contacts with the inner peripheral surface of the cylinder 109.

Further, a bumper 128 is provided in the body part 106. The bumper 128 is provided between the cylinder 109 and the ejection part 102 in the direction along the center line C1. The bumper 128 is a cushioning member made of synthetic rubber. A portion of the bumper 128 is located in the cylinder 109. The bumper 128 has a shaft hole 129. A piston lower chamber 123 is formed between the piston 121 and the bumper 128 in the cylinder 109. The sealing member 113 airtightly separates the piston lower chamber 123 and the piston upper chamber 120. A return air chamber 124 is provided between the body part 106 and an outer peripheral surface of the cylinder 109. The holder 135 airtightly separates the accumulator 110 and the return air chamber 124.

Passages 125 and 126 radially penetrating the cylinder 109 are provided. A check valve 127 is provided on an outer surface of the cylinder 109. The check valve 127 opens and closes the passage 125. The passage 126 always connects the piston lower chamber 123 and the return air chamber 124. The passage 126 is arranged between the passage 125 and the ejection part 102 in a direction along the center line C1.

Further, an energizing member 130 is provided in the body part 106. The energizing member 130 is, as an example, a metal spring. The cylinder 109 is energized by an energizing force of the energizing member 130 so as to approach the valve seat 119 in the direction along the center line C1. The cylinder 109 is energized by pressure in the first gas chamber 139 in a direction of approaching the valve seat 119. The cylinder 109 is energized by pressure in the second gas chamber 142 in a direction away from the valve seat 119.

The ejection part 102 is fixed to the body part 106, and the ejection part 102 has an ejection path 133. The driver blade 122 is operable in the shaft hole 129 and the ejection path 133 in the direction along the center line C1. The push lever 134 is attached to the ejection part 102, and the push lever 134 is movable in the direction along the center line C1 with respect to the ejection part 102. A magazine 201 is attached to the ejection part 102, and fasteners 202 housed in the magazine 201 are sequentially sent to the ejection path 133.

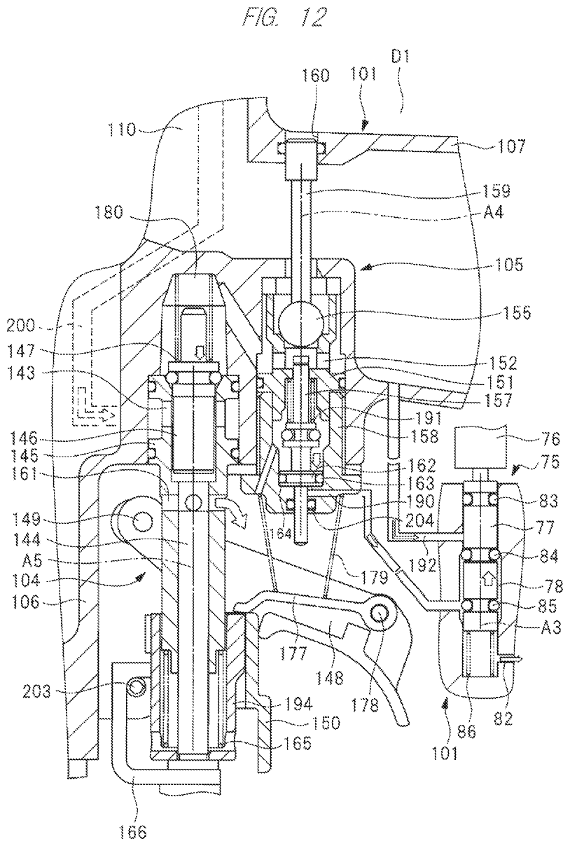

Structures of the trigger valve 105 and the push lever valve 104 will be described with reference to FIGS. 12, 13, 14, and 15. The push lever valve 104 includes a plunger 144, a valve element 146, a valve body 145, a pressure chamber 180, and an energizing member 147. The valve body 145 does not move relative to the housing 101. The valve body 145 has a cylinder shape, and operably supports the plunger 144 and the valve element 146. The valve body 145 has a passage 143 and an exhaust passage 161. The passage 143 connects to the exhaust valve chamber 114 via a passage 200.

The plunger 144 and the valve element 146 are operable along a center line A5. The energizing member 147 is, as an example, a metal spring, and the energizing member 147 energizes the valve element 146. The valve element 146 connects and shuts off the pressure chamber 180 and the passage 143. The plunger 144 connects and shuts off the passage 143 and the exhaust passage 161. A shaft member 166 is operably provided with respect to the body part 106. The shaft member 166 is connected to the push lever 134. A guide member 150 is provided in the housing 101, and the guide member 150 holds a transmission member 194. The shaft member 166 and the transmission member 194 operate along the center line A5.

An energizing member 165 is provided between the valve body 145 and the transmission member 194. The energizing member 165 is, as an example, a metal spring. An energizing force of the energizing member 165 is transmitted to the shaft member 166 via the transmission member 194. The energizing member 165 energizes the transmission member 194 and the shaft member 166 in a direction away from the trigger valve 105. A stopper 203 is provided on the housing 101, and the shaft member 166 pressed by the energizing member 165 contacts with the stopper 203 and stops. When the push lever 134 is pressed against the workpiece W1 and operates, an operating force of the push lever 134 is transmitted to the shaft member 166. The shaft member 166 operates against the energizing force of the energizing member 165. An operating force of the shaft member 166 is transmitted to the plunger 144 and the transmission member 194. When the transmission member 194 contacts with an arm 177, the arm 177 operates.

The trigger 148 is operably attached to the housing 101 about a support shaft 149. The arm 177 is attached to the trigger 148 via a support shaft 178. The arm 177 is rotatable about the support shaft 178 as a fulcrum. An elastic member 179 is provided, and the elastic member 179 energizes the arm 177 and the trigger 148. The arm 177 and the trigger 148, which are energized by the elastic member 179, contact with the guide member 150 and stop at an initial position.

The trigger valve 105 has a cylindrical guide part 151, a ball-shaped valve element 155, a plunger 157, a body 158, and an energizing member 191. The guide part 151 has a passage 152, and the passage 152 connects to the pressure chamber 180. A shaft 159 is connected to the valve element 155. A shaft hole 160 penetrating the handle 107 is provided, and an end portion of the shaft 159 is arranged in the shaft hole 160. The shaft 159 and the valve element 155 are operable in a direction along a center line A4. When the valve element 155 is energized by the pressure in the accumulator 110 and operates, it shuts off the accumulator 110 and the passage 152. When the valve element 155 operates against the pressure in the accumulator 110, it connects the accumulator 110 and the passage 152.

The plunger 157 has a flange 162, and a sealing member 163 is attached to an outer peripheral surface of the flange 162. An air chamber 164 is formed between the flange 162 and the body 158. A sealing member 204 is provided on the body 158, and the sealing members 163 and 204 seal the air chamber 164. The body part 106 has a passage 190 connecting to the air chamber 164. The energizing member 191 energizes the plunger 157 in a direction away from the valve element 155. The energizing member 191 is, as an example, a metal spring. The plunger 157 is energized by pressure in the air chamber 164 in a direction of approaching the valve element 155 against the energizing force of the energizing member 191.

A passage 192 connects to the accumulator 110. Further, a valve 75 and a solenoid 76 are provided in the housing 101. When no current flows through the solenoid 76, the plunger 77 operates by the energizing force of the energizing member 86, and the valve 75 is stopped in an initial state. The valve 75 in the initial state connects the passage 190 and the exhaust passage 82, and shuts off the passage 192 and the passage 190. Therefore, the air chamber 164 connects to the exterior D1 via the passage 190 and the exhaust passage 82. Accordingly, the pressure in the air chamber 164 becomes atmospheric pressure.

In contrast, when a current flows through the solenoid 76, the plunger 77 operates against the energizing member 86 and the valve 75 is stopped in an operating state. The valve 75 in the operating state connects the passage 192 and the passage 190, and shuts off the passage 190 and the exhaust passage 82. Therefore, compressed air in the accumulator 110 is supplied to the air chamber 164 through the passages 192 and 190, and the pressure in the air chamber 164 becomes higher than the atmospheric pressure.

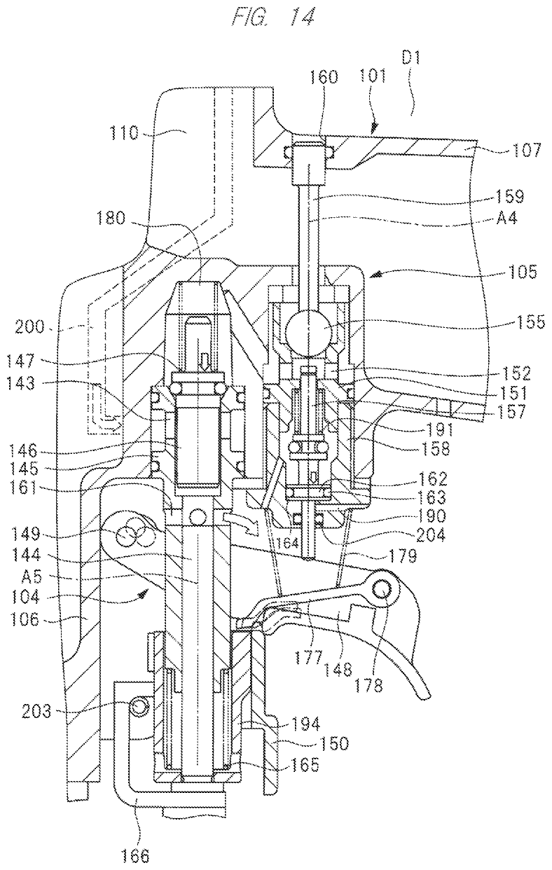

The driving tool 100 has a configuration shown in FIG. 7. A user can operate a mode selection lever 92 to mutually switch a first mode, a second mode, and a third mode. As shown in FIG. 9, the mode selection lever 92 is operable about an operating shaft 92A with respect to the housing 101, that is, is rotatably attached to the housing 101. A support shaft 149 is provided on the operating shaft 92A. The support shaft 149 is provided at a position eccentric from a rotation center X1 shown in FIG. 14. The rotation center X1 is a rotation center of the operating shaft 92A. When the mode selection lever 92 is operated, the support shaft 149 revolves around the rotation center X1. Therefore, when the mode is switched, the arm 177 operates in a direction intersecting with a center line A4 regardless of whether the operating force is applied to the trigger 148.

A position of the support shaft 149 in the first mode is a position farthest from the plunger 157. A position of the support shaft 149 in the third mode is a position closest to the plunger 157. A position of the support shaft 149 in the second mode is between the position of the support shaft 149 in the first mode and the position of the support shaft 149 in the third mode. A position of the support shaft 149 is a position in the direction intersecting with the center line A4.

When the first mode or the second mode is selected and the push lever 134 is pressed against the workpiece W1 to then apply the operating force to the trigger 148, the arm 177 is pressed against the plunger 157 and the plunger 157 operates. When the third mode is selected and the push lever 134 is pressed against the workpiece W1 to then apply the operating force to the trigger 148, the arm 177 is maintained in a state of separating from the plunger 157.

An example of using the driving tool 100 will be described.

(Example of selecting Third Mode) When the user selects the third mode, the microcomputer 89 starts. Further, when the operating force to the trigger 148 is released, the arm 177 and the trigger 148 are pressed against the guide member 150 and stop at the initial position as shown in FIG. 12.

When the user separates the push lever 134 from the workpiece W1, the push lever valve 104 is stopped in the initial state. The plunger 144 stops at the initial position and opens the exhaust passage 161. Further, the valve element 146 stops at the initial position and shuts off the pressure chamber 180 and the passage 143. When the push lever valve 104 is stopped in the initial state, the exhaust valve chamber 114 and the second gas chamber 142 connect to the exterior D1 via the passages 200 and 143 and the exhaust passage 161.

Therefore, the cylinder 109 stops at an initial position where it is pressed against the valve seat 119 as shown in FIG. 9. The cylinder 109 stopping in the initial position shuts off the accumulator 110 and the piston upper chamber 120. Further, the exhaust valve 118 stops at the initial position. The exhaust valve 118 stopping at the initial position opens the exhaust passage 117 as shown in FIG. 9. The piston upper chamber 120 is the same as atmospheric pressure, and the striking part 103 stops at a top dead center. In addition, the transmission member 194 stops at an initial position shown in FIG. 12.

Further, when the third mode is selected, the support shaft 149 stops at an operating position closest to the plunger 157. Therefore, even if the operating force is applied to the trigger 148 and the push lever 134 is pressed against the workpiece W1 to operate the transmission member 194, the transmission member 194 separates from the arm 177. That is, the arm 177 does not transmit the operating force of the push lever 134 and the operating force of the trigger 148 to the plunger 157.

The microcomputer 89 turns off the switch 90 when the third mode is selected and the operating force to the trigger 148 is released to separate the push lever 134 from the workpiece W1. Accordingly, the valve 75 is stopped in a discharge state. When the valve 75 is in the discharge state, the trigger valve 105 is stopped in the initial state shown in FIG. 12. The trigger valve 105 stopped in the initial state causes the valve element 155 to shut off the accumulator 110 and the passage 152.

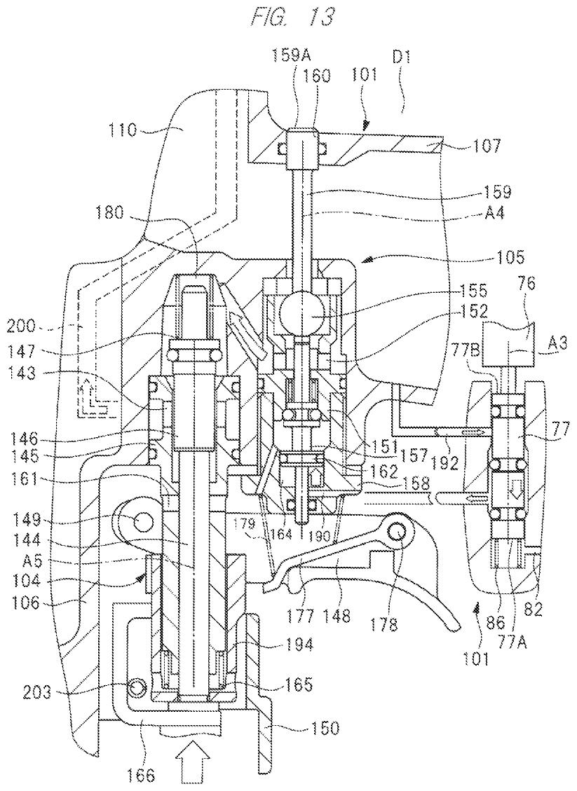

The microprocessor 89 starts the timer when the operating force to the trigger 148 is applied. The microcomputer 89 turns on the switch 90 when the push lever 134 is pressed against the workpiece W1 within a predetermined time from a time point when the operating force is applied to the trigger 148. Therefore, the valve 75 switches from the discharge state of FIG. 12 to the supply state of FIG. 13. When the valve 75 is in the supply state, the pressure in the air chamber 164 becomes higher than the atmospheric pressure and the trigger valve 105 switches from the initial state to the operating state. Specifically, the plunger 157 operates by the pressure in the air chamber 164 against the force of the energizing member 191. The plunger 157 is pressed against the valve element 155, the valve element 155 operates against the force of the accumulator 110, and the valve element 155 connects the accumulator 110 and the passage 152. Therefore, the compressed air in the accumulator 110 is supplied to the pressure chamber 180 through the passage 152.

Further, when the push lever 134 is pressed against the workpiece W1, the operating force of the push lever 134 is transmitted to the plunger 144 via the shaft member 166 as shown in FIG. 13. The plunger 144 operates against the force of the energizing member 165, and the plunger 144 shuts off the passage 143 and the exhaust passage 161. In addition, the plunger 144 is pressed against the valve element 146, the valve element 146 operates against the force of the energizing member 147, and the valve element 146 stops at an operating position. The valve element 146 stopping at the operating position connects the pressure chamber 180 and the passage 143.

Therefore, compressed air is supplied from the pressure chamber 180 to the exhaust valve chamber 114 and the second gas chamber 142 through the passages 143 and 200. A state where the push lever valve 104 shuts off the passage 143 and the exhaust passage 161 and connects the pressure chamber 180 and the passage 143 is the operating state of the push lever valve 104.

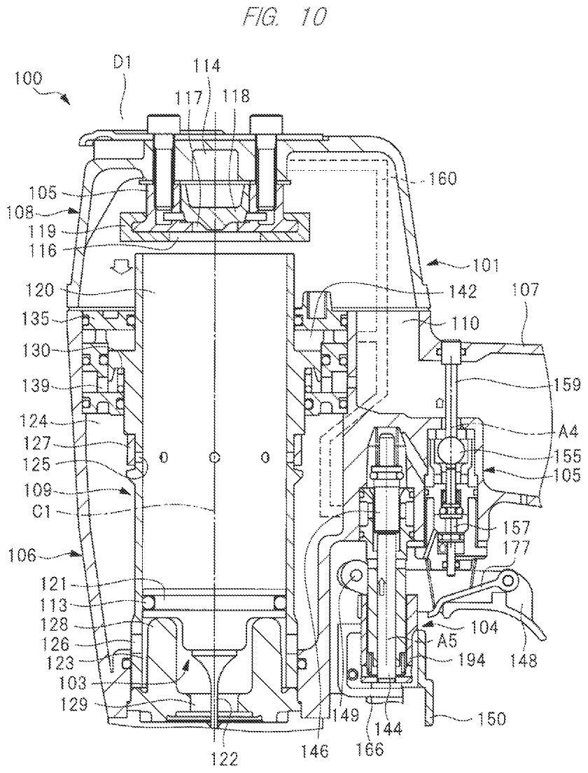

Consequently, as shown in FIG. 10, the exhaust valve 118 operates to close the exhaust passage 117. Further, the cylinder 109 operates against the force of the energizing member 130, and the cylinder 109 separates from the valve seat 119. Therefore, the accumulator 110 and the piston upper chamber 120 are connected to each other, and the pressure in the piston upper chamber 120 rises. The striking part 103 descends from the top dead center toward the bottom dead center at the pressure in the piston upper chamber 120. The driver blade 122 hits the fastener 202 in the ejection path 133, and the fastener 202 is driven into the workpiece W1.

After the striking part 103 drives the fastener 202 into the workpiece W1, the piston 121 collides with the bumper 128. A position of the striking part 103 at a time point when the piston 121 collides with the bumper 128 is the bottom dead center. Further, while the striking part 103 is descending, the pressure in the piston lower chamber 123 rises.

When the user maintains the state of applying the operating force to the trigger 148 and the push lever 134 is separated from the workpiece W1 after the striking part 103 reaches the bottom dead center, the plunger 144 operates by the force of the energizing member 165 and connects the passage 143 and the exhaust passage 161. Further, the valve element 146 operates by the force of the energizing member 147 to shut off the pressure chamber 180 and the passage 143. In this way, when the push lever valve 104 returns from the operating state to the initial state, the exhaust valve chamber 114 becomes atmospheric pressure. Further, the cylinder 109 operates by the force of the energizing member 130, is pressed against the valve seat 119, and is stopped in the initial state. The cylinder 109 stopped in the initial state shuts off the accumulator 110 and the piston upper chamber 120, and opens the exhaust passage 117. Consequently, the striking part 103 rises by the pressure in the piston lower chamber 123, and the striking part 103 stops at the time point when the piston 121 contacts with the valve seat 119.

Meanwhile, when the microcomputer 89 detects that the push lever 134 is separated from the workpiece W1, it turns off the switch 90. Consequently, the valve 75 switches from the supply state to the discharge state. Therefore, the air in the air chamber 164 is discharged to an exterior D1. Thus, the plunger 46 of the trigger valve 105 operates by the emerging force of the energizing member 65, and the plunger 146 is stopped in the initial state shown in FIG. 9. Further, the valve element 48 operates by the energizing force of the energizing member 65, connects the accumulator 21 and the passage 52, and shuts off the passage 52 and the exhaust passage 56. In this way, the trigger valve 105 switches from the operating state to the initial state.

The user selects the third mode, and performs an operation of pressing the push lever 134 against the workpiece W1 within a predetermined time with the operating force applied to the trigger 148, so that the user can sequentially drive the fasteners 202. Further, the microcomputer 89 continues to turn off the switch 90 when a predetermined time has elapsed from the time point of applying the operating force to the trigger 148 in the state of separating the push lever 134 from the workpiece W1. Therefore, when the push lever 134 is pressed against the workpiece W1 after the predetermined time has elapsed from the time point of applying the operating force to the trigger 148, the trigger valve 105 maintains the initial state. That is, the striking part 103 stops at the top dead center and does not operate. The microprocessor 89 resets the timer once the user releases the operating force to the trigger 148. That is, the flowchart of FIG. 8 also applies to the driving tool 100.

When the third mode is selected and the valve 75 is switched between the discharge state and the supply state, the driving tool 100 switches the trigger valve 105 between the initial state and the operating state. Switching between the initial state and the operating state of the trigger valve 105 is performed by pressure due to the compressed air in the accumulator 110. The solenoid 76 only controls the operation of the plunger 77 of the valve 75. Accordingly, the driving tool 100 can obtain the same effect as that of the driving tool 10.

Further, as shown in FIG. 13, the end portion 159A of the shaft 159 is arranged at a position where it receives atmospheric pressure, and is exposed to the exterior D1. Therefore, when the shaft 159 is operated, an area that receives the pressure in the accumulator 110 can be narrowed. Accordingly, the operating force for switching the trigger valve 105 from the initial state to the operating state can be reduced.

(Example in which User selects First Mode) When the user selects the first mode, the microcomputer 89 is stopped. When the user selects the first mode and the user releases the operating force to the trigger 148 to separate the push lever 134 from the workpiece W1, the arm 177 is separated from the plunger 157 as shown in FIG. 14. That is, the trigger valve 105 maintains the initial state. Further, when the user selects the first mode and the operating force is applied to the trigger 148 to separate the push lever 134 from the workpiece W1, the trigger valve 105 maintains the initial state. The user selecting the first mode, and the push lever 134 is pressed against the workpiece W1 with the operating force applied to the trigger 148. Consequently, the operating force of the push lever 134 is transmitted to the plunger 144 via the shaft member 166, and the push lever valve 104 switches from the initial state to the operating state.

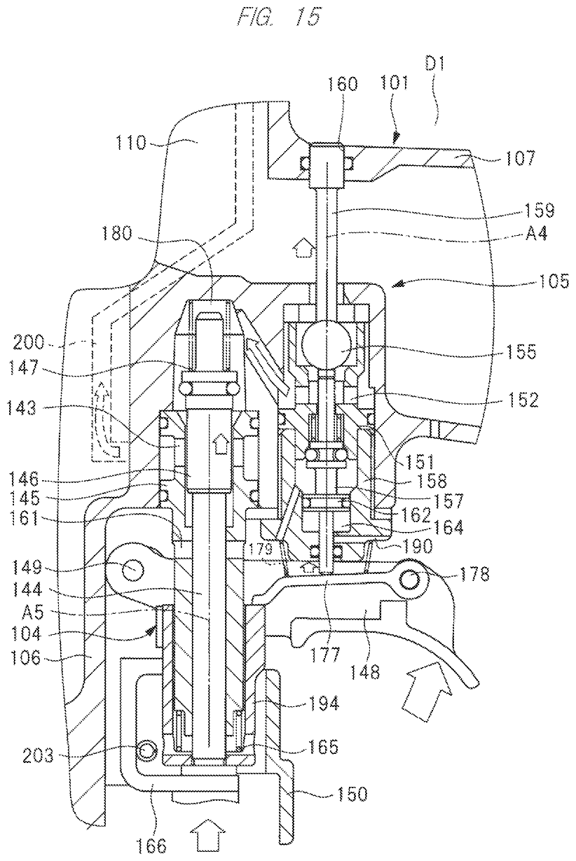

Further, the operating force of the shaft member 166 is transmitted to the transmission member 194, and the operating force of the transmission member 194 is transmitted to the plunger 157 via the arm 177 as shown in FIG. 15. Therefore, the trigger valve 105 switches from the initial state to the operating state. Accordingly, the compressed air in the accumulator 110 is supplied to the piston upper chamber 120, and the striking part 103 descends.

When the push lever 134 is separated from the workpiece W1 with the user applying the operating force to the trigger 148 after the striking part 103 reaches the bottom dead center, the plunger 144 operates by the energizing force of the energizing member 165. Therefore, the push lever valve 104 switches from the operating state to the initial state. Accordingly, the striking part 103 rises, and the striking part 103 stops at the top dead center. The user selects the first mode, and can repeat more than once the operation of pressing the push lever 134 against the workpiece W1 and the operation of separating the push lever 134 from the workpiece W1 in the state where the operating force is applied to the trigger 148.

(Example in which User selects Second Mode) When the user selects the second mode, the microcomputer 89 is stopped. When the user selects the second mode and the push lever 134 is separated from the workpiece W1 to release the operating force to the trigger 148, the trigger valve 105 maintains the initial state and the push lever valve 104 maintains the initial state. Further, when the user selects the second mode and the user presses the push lever 134 against the workpiece W1 to release the operating force to the trigger 148, the push lever valve 104 maintains the operating state and the trigger valve 105 maintains the initial state.

When the user selects the second mode and the operating force is applied to the trigger 148 with the push lever 134 pressed against the workpiece W1, the arm 177 operates about the transmission member 194 as a fulcrum as shown in FIG. 15 and the arm 177 is pressed against the plunger 157 and the trigger valve 105 switches from the initial state to the operating state. Therefore, the striking part 103 decreases descends.

When the user releases the operating force to the trigger 148 or separates the push lever 134 from the workpiece W1 after the striking part 103 reaches the bottom dead center, the trigger valve 105 switches from the operating state to the initial state. Therefore, the striking part 103 rises, and the striking part 103 stops at the top dead center. When the user selects the second mode, the user can repeat more than once the operation of applying the operating force to the trigger 148 and the operation of separating the push lever 134 from the workpiece W1 to release the operating force to the trigger 148 in the state where the push lever 134 is pressed against the workpiece W1.

Incidentally, when the second mode is selected and when the push lever 134 is pressed against the workpiece W1 with the operating force applied to the trigger 148, the transmission member 194 does not contact with the arm 177. Accordingly, the trigger valve 105 maintains the initial state. Incidentally, as described in the first embodiment, various sensors 94 can be provided in the housing 101. The various sensors 94 include at least one or more of a pressure sensor, a temperature sensor, a humidity sensor, and an acceleration sensor. If the housing 101 is provided with a display unit, the microcomputer 89 processes signals of the various sensors 94 and the microcomputer 89 can display on the display unit and warn: an operating time from the operation of the user to the operation of the striking part 103; operating speed of the striking part 103; and an inspecting and repairing time of the bumper 128.

An example of the meaning of the matters disclosed in the embodiments is as follows. The driving tools 10 and 100 are examples of driving tools. The accumulators 21 and 110 are examples of a gas accommodating chamber. The piston upper chambers 32 and 120 are examples of pressure chambers. The striking parts 13 and 103 are examples of striking parts. The fasteners 72 and 202 are examples of fasteners. The triggers 14, 148 and the push levers 16, 134 are examples of operating members. The push levers 16 and 134 are examples of contact members. The trigger valves 45 and 105 are examples of switching mechanisms. Each initial state of the trigger valves 45 and 105 is an example of a first state. Each operating state of the trigger valves 45 and 105 is an example of a second state. The first mode and the second mode are examples of connection modes. The third mode is an example of a shut-off mode or a magnetic valve mode. The mode selection lever 92, the trigger 14, and the arm 42 are examples of mode switching mechanisms. The mode selection lever 92, the trigger 148, and the arm 177 are examples of mode switching mechanisms.

The valve 75 is an example of a valve. The supply state of the valve 75 is an example of a supply state. The discharge state of the valve 75 is an example of a discharge state. The solenoid 76 is an example of an actuator. The plungers 46 and 157 and the valve element 155 are examples of a first operating member. The gas chambers 68 and 164 are examples of a gas chamber. The plunger 77 is an example of a second operating member. The trigger switch 87, the push lever switch 88, and the microcomputer 89 are examples of detectors. The microcomputer 89 and the switch 90 are examples of controllers. A processing in which the microcomputer 89 proceeds from step S4 to step S5 in FIG. 8 is an example of first control. A processing in which the microcomputer 89 proceeds from step S4 to step S7 in FIG. 8 is an example of second control.

The driving tool is not limited to the disclosed embodiments, and can be variously changed without departing from the gist thereof. The gas is compressible gas, and includes inert gas such as nitrogen gas and noble gas besides air. Further, in FIG. 7, regardless of the mode selected, a current of the power supply 91 may flow through the microcomputer 89 to start the microcomputer 89. In this case, a mode detection sensor 93 is provided. The mode detection sensor 93 detects the mode selected by operating the mode selection lever 92 and outputs a signal. The microcomputer 89 can turn on the switch 90 when it detects that the third mode has been selected. The microcomputer 89 keeps the switch 90 off when it detects that the first mode or the second mode has been selected.

The actuator is a mechanism in which a current flows to operate the plunger 77 of the valve 75 against the force of the energizing member 86. As the actuator, an electric motor and a rack and pinion mechanism can be used instead of the solenoid 76. The electric motor rotates when a current is supplied, and stops when the current is shut off. The rack and pinion mechanism converts a rotation force of the electric motor into the operating force of the plunger 77 of the valve 75.

The operating member includes a lever, a button, an arm and the like. The operation of the operating member may be either a rotational operation within a predetermined angle range or a linear reciprocating operation. The controller may be a single electric component or electronic component, or may be a unit having a plurality of electric components or a plurality of electronic components. Electrical or electronic components include a processor, a control circuit, and a module. The pressure chamber and the air chamber include spaces, areas and passages where a gas is supplied and discharged. A path for supplying the gas to the pressure chamber includes a port, a passage, a hole, and a gap. The first mode can be defined as a continuous mode, and the second mode can be defined as a single mode.

### EXPLANATION OF REFERENCE NUMERALS

10, 100 . . . Driving tool; 13, 103 . . . Striking part; 14, 148 . . . Trigger; 16, 134 . . . Push lever; 21, 110. . . Accumulator; 32, 120 . . . Piston upper chamber; 42, 177 . . . Arm; 45, 105 . . . Trigger valve; 46, 77, 157 . . . Plunger; 68, 164 . . . Gas chamber; 72, 202 . . . Fastener; 75 . . . Valve; 76 . . . Solenoid; 87 . . . Trigger switch; 88 . . . Push lever switch; 89 . . . Microcomputer; 90 . . . Switch; 92 . . . Mode selection lever; and 155 . . . Valve element.

1-9. (canceled)

10. A driving tool comprising:
a gas accommodating chamber accommodating a gas;
a pressure chamber to which the gas is supplied from the gas accommodating chamber;
a striking part operating in a direction of hitting a fastener by pressure in the gas supplied to the pressure chamber;
an operating member to and from which an operating force of a user is applied and released; and
an actuator shutting off the gas accommodating chamber and the pressure chamber when the operating force to the operating member is released, and connecting the gas accommodating chamber and the pressure chamber by operating due to power supplied when the operating force to the operating member is added.

11. The driving tool according to claim 10, further comprising:
a first operating member operating to shut off and connect the gas accommodating chamber and the pressure chamber; and
a gas chamber causing the first operating member to operate,
wherein the actuator operates to supply or discharge the gas in the gas accommodating chamber to or from the gas chamber.

12. The driving tool according to claim 11, further comprising a valve including a supply state of supplying the gas in the gas accommodating chamber to the gas chamber and a discharge state of discharging the gas supplied to the gas chamber,
wherein the actuator switches the supply state and the discharge state of the valve.

13. The driving tool according to claim 10, further comprising:
a detector detecting application and release of an operating force to the operating member and
a controller controlling supply and stop of power to the actuator based on a detection result of the detector,
wherein the controller performs:
control for stopping the supply of the power to the actuator when the operating force to the operating member is released, and
control for supplying the power to the actuator when the operating force is applied to the operating member.

14. The driving tool according to claim 13,
wherein the operating member has:
a trigger to which the user applies an operating force; and
a contact member capable of contacting with and separating from a workpiece into which the fastener is driven, and
the controller performs:
first control for admitting the supply of the power to the actuator when the contact member is caused to contact with the workpiece and the operating force is applied to the contact member within a predetermined time from a time point when the operating force is applied to the trigger; and
second control for stopping the supply of the power to the actuator when the predetermined time elapses from the time point when the operating force is applied to the trigger in a state where the contact member separates from the workpiece.

15. The driving tool according to claim 14,
wherein the controller includes:
a first mode selected by the user before performing an operation of causing the contact member to contact with the workpiece in the state where the operating force is applied to the trigger; and
a second mode selected by the user before performing an operation of applying the operating force to the trigger in a state where the contact member contacts with the workpiece.

16. The driving tool according to claim 12,
wherein the valve has a second operating member, and
an end portion of the first operating member in an operating direction, and an end portion of the second operating member in the operating direction are each arranged at a position that receives atmospheric pressure.

17. The driving tool according to claim 12,
wherein the valve has a second operating member, and
both ends of the second operating member in an operating direction are each arranged at a position that receives atmospheric pressure.

18. The driving tool according to claim 10, further comprising a controller provided to control supply and stop of power to the actuator
wherein the operating member includes:
a trigger to which the user applies an operating force;
a contact member capable of contacting with and separating from a workpiece into which the fastener is driven, an operating force being applied to the contact member by contacting with the workpiece, and
the controller causes the striking part to operate in a direction of hitting the fastener by supplying power to the actuator when the contact member contacts with the workpiece to apply an operating force to the contact member within a predetermined time from a time point when an operating force is applied to the trigger.

19. A driving tool comprising:
a gas accommodating chamber accommodating a gas;
a pressure chamber to which the gas is supplied from the gas accommodating chamber;
a striking part operating in a direction of hitting a fastener by pressure in the gas supplied to the pressure chamber;
an operating member to and from which an operating force of a user is applied and released;
a valve including a supply state of supplying the gas in the gas accommodating chamber to the gas chamber and a discharge state of discharging the gas supplied to the gas chamber; and
an actuator switching the supply state and the discharge state by operating due to power supplied when the operating force to the operating member is added.

20. A driving tool comprising:
a gas accommodating chamber accommodating a gas;
a pressure chamber to which the gas is supplied from the gas accommodating chamber;
a striking part operating in a direction of hitting a fastener by pressure in the gas supplied to the pressure chamber;
an operating member to and from which an operating force of a user is applied and released;
a switching mechanism having a first state of shutting off the gas accommodating chamber and the pressure chamber when the operating force to the operating member is released, and a second state of connecting the gas accommodating chamber and the pressure chamber when the operating force is applied to the operating member;
a valve having a supply state of supplying the gas in the gas accommodating chamber to the switching mechanism to make the switching mechanism the second state, and a discharge state of discharging the gas supplied to the switching mechanism to make the switching mechanism the first state; and
an actuator operated by supply of power and switching the supply state and the discharge state of the valve,
wherein the switching mechanism has:
a first operating member operating to shut off and connect the gas accommodating chamber and the pressure chamber; and
a gas chamber causing the first operating member to operate,
the valve has a second operating member that operates to supply or discharge the gas in the gas accommodating chamber to or from the gas chamber, and
the actuator causes the second operating member to operate.
